(19) United States
(12) Patent Application Publication
(10) Pub. No.: US 2014/0358606 A1
(43) Pub. Date: Dec. 4, 2014

(54) SYSTEM AND METHOD FOR RECOMMENDING AN EMPLOYEE FOR A ROLE

(71) Applicant: Linkedln Corporation, Mountain View, CA (US)

(72) Inventor: Mark Everett Hull, San Jose, CA (US)

(73) Assignee: Linkedln Corporation, Mountain View, CA (US)

(21) Appl. No.: 13/905,827

(22) Filed: May 30, 2013

(51) Int. Cl. G06Q 10/06

(52) U.S. Cl. CPC G06Q 10/063112
USPC 705/7.14

(57) ABSTRACT

A system and method are provided for promoting internal mobility within an organization and, in particular, for recommending employees and/or teams of employees of the organization for a new project or for another role within the organization. Data reflecting employees' professional skills, reputation, productivity, experience, work histories and other attributes are collected and analyzed to produce relevance ratings for each of associated criteria. When criteria for a new team or role are provided, the system uses employees' relevance ratings for those criteria, and/or other factors, to recommend them for each role.

### FIELD

This invention relates to computer systems and data processing. In particular, a system, apparatus and methods are provided for identifying one or more existing employees of an organization for new roles or positions within the organization.

### BACKGROUND

Currently, when an organization wants to staff a new project, it may be able to identify one or more people who are available for the project's team, but generally is unable to conduct a detailed analysis of all of its employees to find preferred or optimal candidates, or candidates that suit the project's purpose better than others. Without data regarding employees' skills, project histories, performance appraisals, educations, training and so on, it may default to simply finding a group of people who are available, without regard to whether they will form a good team that is likely to be successful.

Even if the organization operates multiple separate applications that contain information regarding its employees, it is unable to execute a single or unified search across them to find data relevant to determining an employee's suitability for the project, or to otherwise correlate relevant data from the different applications to identify employees that are or are not suitable candidates. Because different projects may be very different in nature or purpose, they may involve very different subject matter, and use different technologies or technology platforms, and therefore may be best served by having team members with compatible attributes.

### BRIEF DESCRIPTION OF THE DRAWINGS

FIG. 1 is a block diagram of a system for recommending employees and/or teams of an organization for a project or role, according to some embodiments of the invention.

FIG. 2 is a flow chart demonstrating a method of recommending employees and/or teams of an organization for a project or role, according to some embodiments of the invention.

FIG. 3 is a block diagram of an apparatus for recommending an organization's employees for specified roles, according to some embodiments of the invention.

### DETAILED DESCRIPTION OF ILLUSTRATIVE EMBODIMENTS

The following description is presented to enable any person skilled in the art to make and use the invention. Various modifications to the disclosed embodiments will be readily apparent to those skilled in the art, and the general principles defined herein may be applied to other embodiments and applications without departing from the scope of the present invention. Thus, the present invention is not intended to be limited to the embodiments shown.

In embodiments of the invention, a system, apparatus and methods are provided for recommending, from one organization's employees or members, a team of people having desired skills, knowledge, aptitude, talents, experience and/or other attributes that are believed to be conducive to a successful project. In other embodiments, the organization may wish to find individual employees to fill separate roles (e.g., new jobs) or to form an ad-hoc team.

In these embodiments, sets of disparate data are harvested, filtered, analyzed, correlated or otherwise processed to find information reflecting attributes of the organization's employees/members that may be useful in estimating how well suited the employees are for a new project or role. For example, the organization may operate multiple separate applications for distinct purposes, perhaps a human resources database, one or more applications to support sales and/or marketing, a program code library or repository, a collaboration application, communication software and so on. Whereas normally there would be no way for the organization to correlate data from these multiple applications to assemble a unified impression of even a single employee or member, let alone multiple employees, embodiments of the invention make this possible.

When a team is to be formed, whether to work on a new project, help with an existing project or for some other reason, one or more criteria or attributes of the project are selected, and data referred to above are sifted and analyzed to identify employees/members that do or do not match the criteria, and may be ranked or weighted according to how well they match. For example, relevance values or ratings can be generated regarding how well a particular employee or member matches criteria specified for the project.

Alternatively, data that may be analyzed to determine an employee's suitability for a role may be processed in advance, perhaps to generate the relevance values or rating. Then, when an internal recruiter or other representative of the organization needs to assemble a team or pick an individual for a role, the system can quickly filter the relevance values or ratings to form a team or identify an individual.

An “organization” should be understood herein to encompass a corporation, a business, a government agency, a not-for-profit group, a school or any other such entity, or may refer to a distinct department, division, subsidiary company or other entity within a larger organization. Similarly, references to “an employee” of an organization should be understood to refer to an employee, a member, a volunteer, a contractor or any other person who could be considered part of the organization.

To enable an organization to find employees that would be suitable members of a team, or to find an employee that matches particular criteria for some other purpose, data from multiple applications and/or services are analyzed to obtain an organization-specific profile of each candidate employee that reveals whether, and how well, those criteria match the employee. The data may be processed by filtering out irrelevant information, weighting some data (e.g., data of a particular application) more or less than other data, using data from one application to bolster or disprove other data, and so on.

For example, it may be noticed from one application that a particular employee uploads presentations (e.g., PowerPoint® slides) on a specific topic fairly regularly. That fact may indicate that she has a particular skill or interest in that area. By analyzing other data, such as conversations she has conducted via electronic mail or instant messaging, or documents she has shared with other employees, it might be determined that she indeed authored the presentations (and therefore most likely does have skill regarding that topic) or that she is simply uploading presentations created by other employees.

As another example, an employee's résumé may indicate that he has several years of experience with projects involving digital photographs. By sifting through other data—such as his conversations with other employees, tasks he has completed, his job responsibilities and so on—it may be determined that his experience is specific to publishing or processing photographs, and not hardware for taking photographs or some other aspect of digital photography.

When determining how well a particular employee or existing team reflects desired criteria, the data that are analyzed may depend upon the type or role or team being assembled. For example, when assembling a software development team, resources and data that are analyzed may be associated with tools normally used by software engineers; when assembling a sales team, the resources and data that are analyzed may include client management tools.

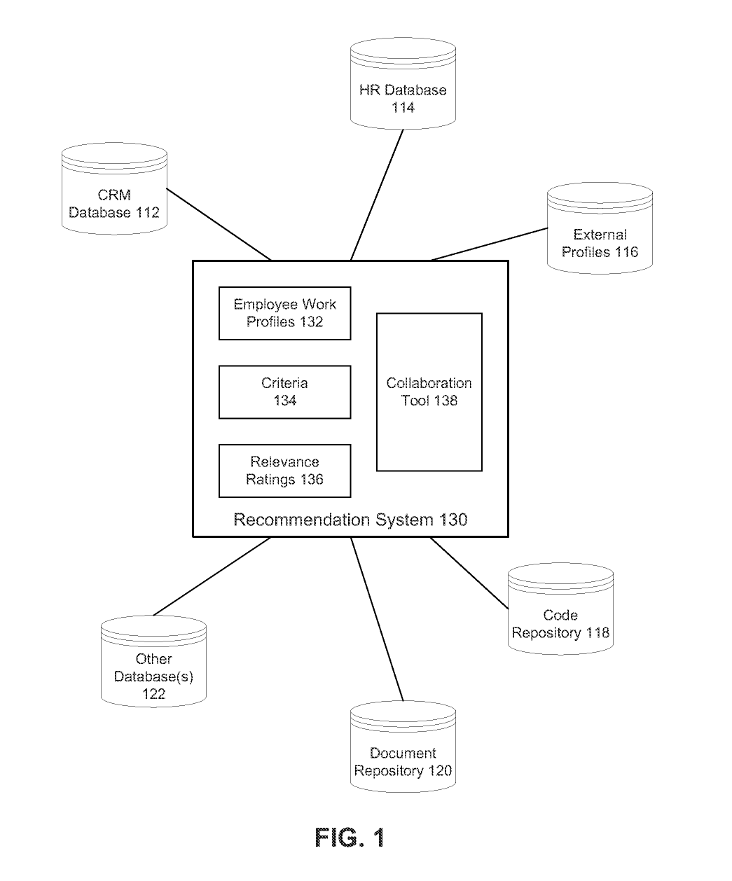

FIG. 1 is a block diagram of a system for recommending an organization's employees for specified roles, according to some embodiments of the invention.

In these embodiments, recommendation system 130 includes (or at least uses) employee work profiles 132, criteria 134 and relevance ratings 136. Based on criteria 134, system 130 evaluates employees based on their profiles 132 and/or other data described below, and produces relevance ratings 136. Employee work profiles 132 may alternatively be titled “internal profiles” or “work-related profiles” because, as discussed below, they may primarily encompass information and characteristics of employees that are specific to, or at least related to, the organization and the employees' work-related activities and attributes. For example, actions and transactions of employees (and/or teams) involving repositories 112, 114, 116, 118, 120, 122 may be posted to or available through their work profiles 132. By way of contrast, external profiles 116 may encompass personal characteristics of employees and/or information not internal to the organization, and may be available to people outside the organization.

In addition to recommending employees for specified roles, system 130 hosts or operates collaboration tool 138, which is an application or service available to the organization's employees. This tool offers utilities such as chat, document-sharing, task-sharing, electronic mail, code review and so on, and may populate employee work profiles 132 with employees' collaboration activities.

In some embodiments of the invention, collaboration tool 138 is a social networking service intended for use within an organization, such as collaboration services that may be offered by LinkedIn Corporation. Illustratively, tool 138 may allow for employees to endorse other employees' skills, to award “karma points” or other indicia to show support or admiration for the receiving employee, to attend virtual meetings, to view other employees' experience, etc.

Collaboration tool 138 supports individual teams by providing them a common virtual space for utilities such as those described above, to share team efforts, collaborate via audio, video and/or text, interact with external applications/services, etc. Activity by team members in support of the team may be posted to a team profile within profiles 132, which may be accessible only to the team's members and possibly some other employees of the organization (e.g., internal recruiters).

Instead of posting information to profiles 132, or in addition to posting to these profiles, the collaboration application/service may maintain a central data repository or database within the organization (e.g., as part of recommendation system 130). This repository may store work conversations between employees, track project tasks, conduct or facilitate meetings, store records of social activity and so on. In general, tool 138 promotes communication within the organization and especially within teams of employees, and reflects activity and accomplishments of teams and/or individuals.

Thus, data assembled by collaboration tool 138 allows insight into the skills, experience and expertise of individual employees, and also into how well specific groups of individuals (e.g., existing teams) communicate and work together. As but one example, the collaboration tools may record the completion of 100 tasks by a given team within a short period of time, whereas other teams have completed at most 60 tasks within the same period of time. This may allow system 130 to assign a higher “productivity” score for the individuals of the given team, at least when working together.

System 130 may comprise one computer server or multiple computer servers operating cooperatively. Alternatively, recommendation system 130 may operate as a virtual computer hosted by one or more computer servers.

System 130 is coupled to data repositories used by multiple different applications and/or services other than collaboration tool 138. In some embodiments, some or all of the data repositories may be part of, or may be considered part of, system 130, or at least the portions of the data repositories that pertain to the organization and its employees. However, each application or service associated with a repository may have separate access controls, meaning that normally an organization employee may need to separately login to each application/service in order to retrieve or review his or her activity regarding that application or service. Not all repositories depicted in FIG. 1 are employed in all embodiments of the invention.

CRM (Customer Relationship Management) database 112 is used by the organization that operates system 130 to maintain contact and connections with clients/customers, facilitate sales, track leads, collaborate among different parts of the organization, monitor business processes and/or for other purposes. CRM database 112 may be provided by a third party, such as Salesforce.com, SugarCRM™, Zoho™ and so on.

HR (Human Resources) database 114 is used by the organization to manage employee records, track employees' careers, facilitate the hiring of new employees from outside the organization, etc. HR database 114 may be part of a human resources software program provided by TribeHR™, Kronos®, or other provider.

External profiles 116 include profiles of the organization's employees that may be maintained by an entity other than the organization that operates recommendation system 130, such as social-networking profiles. For example, external profiles 116 may be, or may include, profiles maintained by LinkedIn® Corporation and/or other electronic sites. Profiles 116 may include just personal data, or may also include some public information relating to an employee's association with the organization, such as job title, location, general responsibilities, etc. In general, however, external profiles 116 (or at least portions of the external profiles) are visible to people who are not employees of the organization that operates system 130.

Code repository 118 stores program code developed by employees of the organization. Database 118 may be, or may be part of, source code management software provided by GitHub, Apache™ Subversion®, Canonical Bazaar, or some other party.

Document repository 120 stores documents shared by the organization's employees inside and/or outside the organization. For example, repository 120 may be maintained by SlideShare, Dropbox, Microsoft SharePoint or some other application provider or service provider.

Other database(s) 122 include data repositories other than those depicted in FIG. 1. Illustratively, these may include databases of images and/or other media, electronic mail and/or other types of communications (e.g., instant messages, on-line conferences), etc. For example, other database(s) 122 may include a bug-tracking service such as Jira.

In some embodiments of the invention, some or all of the data described as part of other database(s) 122 could be included in one of repositories 112, 114, 116, 118, 120 of FIG. 1. Similarly, multiple repositories of FIG. 1 may be combined, or a single repository may be divided into multiple repositories. Repositories 112, 114, 116, 118, 120, 122, or portions of such repositories, may reside on computer systems operated by the same organization that operates system 130, or may reside elsewhere. For example, the applications/services that manage the repositories may be cloud-based, in which case the repositories may reside on third-party computer systems.

In some embodiments of the invention, repositories 112-122, or the applications/services that create and manage their data, are modified with APIs (Application Program Interfaces) used by system 130 to obtain relevant data regarding the organization's employees. In some implementations of these embodiments, the APIs operate to post some or all transactions to external profiles 116 and/or work profiles 132.

Work profiles 132 may be distinguished from external profiles 116, in some embodiments of the invention, in that profiles 132 can only be viewed by employees of the organization, whereas profiles 116 may be viewable by people external to the organization. Illustratively, both profiles may be managed by one provider, such as LinkedIn® Corporation. Anyone may access a “public” portion of profile 116 for a particular employee, which may include personal information (e.g., education, employer, a résumé), but only fellow employees can access the “private” portion of the employee's profile, which may be or may be part of employee work profile 132 in FIG. 1.

Thus, in some embodiments of the invention, system 130 accumulates information regarding employees' activity with various applications and services, whether that data is managed by or within system 130, or by an external application. In these embodiments, data regarding employees and project activity may be fluid, with some data stored within recommendation system 130 and other data stored in external repositories. Recommendation system 130, however, is able to access any of the data needed to identify and evaluate employees for inclusion in a project team, without having to individually connect to each repository in order to access relevant information.

For example, although employee work profiles 132 are depicted as part of recommendation system 130, these work profiles may reside on a third-party computer server instead of, or in addition to, on computer servers operated by the organization associated with system 130 (e.g., LinkedIn® Corporation).

Activity posted to work profiles 132, or captured by system 130 without being posted to employee profiles (e.g., as part of collaboration tool 138), may include posting or sharing of documents, employee performance appraisals, discussions regarding products, technologies, team projects and virtually any other organization-related topics. Some or all of this activity is posted to profiles 132 and/or stored by tool 138, and may be reviewed and/or acted on by other employees. For example, an employee may comment on a posting by or regarding another employee, may endorse another employee's skills or knowledge, etc. All of this activity may be considered by system 130 when developing employees' and/or teams' relevance ratings and/or recommending employees and/or existing teams for new projects or roles within the organization.

Postings to work profiles 132 may, but need not, include entire documents or other content (e.g., a document shared by one employee, a new presentation uploaded by another employee). For example, the posting may include metadata regarding a document (e.g., title, topic, subject matter, project that relates to the document), and may include a link to the document stored in repository 120 or another external repository. Therefore, system 130 has access to data for calculating relevance ratings 136, and can offer an operator of system 130 (e.g., an internal recruiter, a manager) evidence supporting a recommendation (or a non-recommendation) of a particular employee.

In summary, in different embodiments of the invention, activity of the organizations' employees and information regarding the employees may be stored in different places (e.g., internal and/or external to the organization) and may normally be accessed in different manners (e.g., via employee and/or team profiles, via an API, from a database). In all of these embodiments, however, recommendation system 130 is configured to access some or all relevant information and use it to rate an employee regarding his or her suitability for a team or role described in terms of specific criteria.

Criteria used to describe a team role or individual role within the organization, and/or for evaluating employees' suitability for such roles (e.g., criteria 134 of FIG. 1) may vary from one embodiment of the invention to another. The actual criteria used may depend upon the type of organization, the type of work performed within the organization, how large the organization is (e.g., how many employees) and/or other factors. Similar, the manner in which relevance ratings (e.g., ratings 136 of FIG. 1) are determined may differ from one embodiment of the invention to another, based on the same or different factors.

In some embodiments of the invention, primary criteria used to evaluate employees and define parameters of a new team or individual role may include, but are not limited to, as the following:
Skills: Desirable (or undesirable) knowledge or expertise. The system may be configurable (e.g., by an internal recruiter) to list any number of individual skills. An employee's “skills” may also indicate his or her level of expertise in the skills.
Reputation: The reputation of a person as reported by colleagues, supervisors, customers and/or others.
Productivity: A measure of productivity of an employee, when working alone and/or in a team.

In these embodiments of the invention, some secondary criteria may also be considered, such as the following. Alternatively, information that could be used to derive values for these criteria may be considered in some primary criteria.
Communication: An employee's skill in communicating within and/or without the organization, verbally and/or written.
Reliability: An employee's dependability, which may indicate a need (or no need) for close supervision.
Goal Orientation: An employee's ability to drive a project forward to completion.
Current Location: Where an employee currently works (e.g., which office or city in an organization having multiple branches).
Relocation: An employee's ability or willingness to relocate.
Timeliness: An employee's observed timeliness regarding meetings, deadlines and so on.
Camaraderie: An employee's ability to get along well with other employees.
Performance: An employee's perceived performance within the organization.
Experience: An employee's experience in certain jobs or roles, within a team, with a particular skill or tool, etc.

Any of these illustrative criteria may be used within the organization to characterize its employees and/or to describe requirements or desires regarding a role to be filled, whether that role is as a member of a team or as an individual. Depending on the type of role, some criteria will be more important than others, and a goal in defining the role in terms of the criteria is to accurately capture traits and characteristics of an employee that would make it more likely than not that he or she would do well in the role.

For example, for a team role, camaraderie and verbal communication skills may be more important than for a solitary role. Productivity and timeliness may be very important if the role requires completion of many tasks according to a stringent schedule. Skills and experience may be tailored to the nature of work associated with the role, and so on.

In embodiments of the invention, data described above are analyzed to determine how well each candidate employee matches some or all criteria. In some implementations, employees may be explicitly rated with regard to various criteria based on their current jobs or roles (i.e., without regard to any new team or role for which they may be considered). In these implementations a recommendation system or apparatus such as system 130 of FIG. 1 (e.g., within collaboration tool 138) may support evaluation of employees according to some or all criteria once, multiple times or on a recurring basis, and record those evaluations for later reference when a new role is defined. In other implementations, however, existing records within some or all of the repositories depicted in FIG. 1, and/or others, are analyzed to derive ratings of individual employees and/or existing teams.

By way of illustration, and not limitation, a repository such as CRM database 112 of FIG. 1 may be analyzed to determine the size of accounts managed by a particular employee, and how much and/or how fast those accounts grew (or shrunk) under her management. The recommendation system or apparatus may use the CRM data to identify and review presentations made to clients, to see if they were well-received (e.g., whether the client representatives “liked” them or shared them), to see if the presentations were regularly updated or allowed to become stale, to determine how often or frequently she communicated with clients, whether they made any complaints about her, etc.

A repository of human resources data such as HR database 114 of FIG. 1 may be analyzed to identify an employee's history of promotions and job assignments, how fast he moved up within the organization, whether he has ever been suspended or placed into a personal improvement program or been subject to other remedial action, etc.

Profiles 116, 132 of FIG. 1 and/or other social activity of an employee may be analyzed to determine how active she is, how well she interacts with others, how popular she is, how many other people she shares information with, how many “likes” or “dislikes” her postings generate, etc.

Information from repositories 118, 120 of FIG. 1, and/or others, may be analyzed to determine how much code or how many documents an employee has uploaded or shared or created, how much the code or documents were used by other people, how well they were rated (if they are able to be rated), etc. Such information may indicate that the employee has knowledge in particular areas. Content of code and/or documents may be analyzed, and/or metadata regarding the code/documents (e.g., timestamps, who downloaded them).

In some embodiments of the invention, an employee's or team's rating for the primary criterion of “Skills” may center upon skill endorsements that employees award each other (e.g., via internal profiles 132 and possibly external profiles 116). For example, a social service or application such as collaboration tool 138 may allow one employee to endorse another employee's possession of any number of specific skills, as a simple binary value (e.g., does or does not have the skill) or on a scale (e.g., A through F, 1 through 5). Skill endorsements that one employee may grant another may be specific to the organization (e.g., products or technology platforms developed within the organization) and/or general (e.g., Java programming, project management, licensing negotiation).

An employee's skills may also be explicitly identified in a performance appraisal or job review, or in some other documentation. And, as already described, skills may be extrapolated implicitly from an employee's activities or status (e.g., presentations regarding a particular topic, accomplishment of tasks that require a certain skill, employment in a position that requires some level of skill in a particular area).

An employee's rating in a skill may be derived as an aggregation of other employees' endorsements. For example, if a software engineer receives 5 endorsements for Java programming, his rating may be 5; a marketing employee who receives 3 endorsements for project management may receive a rating of 3. One endorsement may count for more or less than one point. Illustratively, an endorsement may count as more than one point if the endorser is recognized as the organization's expert in that skill, if the endorser is the employee's supervisor, if the endorsement is scaled (e.g., receives a 5 on a scale of 1 through 5). Illustratively, an endorsement may count as less than one point if the endorser has little or no knowledge of or experience with the skill (meaning that he or she may not be able to gauge whether someone actually has skill), if the endorser is the employee's subordinate, or if the endorsement is scaled (e.g., receives a D⁻ on a stepped scale of A through F).

An existing team may receive a rating for a particular skill by adding or aggregating all team members' ratings. For example, if three software engineers on a team have ratings of 5, 6 and 4 for Java programming, the team may receive a rating of 15 for Java programming. As but one alternative, multiple teams may be rated by aggregating their members' ratings, generating a histogram from the distribution of values, and applying a bell curve function to give the teams ratings between 1 and 5, between A⁺ and F, etc.

If the organization lacks specific data regarding employees' levels of skill, and such skill levels are desired to aid in filling an organizational role, such levels may be extrapolated from other information. For example, an employee's tenure in a position requiring or using a skill may be determined, an employee's title may indicate a degree of experience (e.g., Senior Sales Associate instead of simply Sales Associate), the length of time that has elapsed since an employee was first endorsed with a skill may be determined, etc.

Another primary criterion, productivity, may be rated in some embodiments on the basis of an employee's or team's accomplishments. In some embodiments of the invention, an internal tool such as collaboration tool 138 may allow an organization to track accomplishment of discrete tasks. Illustratively, the tool may be used to define and monitor satisfaction of tasks, or may be used to monitor tasks associated with an external application or service (e.g., an application corresponding to one of repositories 112, 114, 116, 118, 120, 122 of FIG. 1.

For example, software engineers may use Jira or some other third-party bug tracking software. Collaboration tool 138 may record the creation of a bug report within an external Jira data repository, and also the resolution of the bug. The number of bugs resolved by an individual or a team may be used as a measure of productivity, especially when used to compare similar individuals or teams (e.g., those having the same job descriptions—such as software engineer). As another example, productivity of a salesperson may be rated based on information extracted from CRM database 112 (e.g., salesforce.com)

A productivity rating may also or instead involve identifying a number of client presentations made (e.g., by a sales or marketing team), or a number of other resources generated, which may be aggregated to generate a numerical rating. Illustratively, if a team of 5 sales associates makes 2 client presentations in one week, the team may earn a rating of 10; by way of comparison, another team of 4 sales associates that makes 3 presentations in two weeks may yield a rating of 6 (e.g., (4*3)÷2). Alternatively, ratings could be generated as described above for skills, wherein multiple teams' or individuals' tasks are aggregated and used to create a histogram, with the different values mapped to a bell curve to assign a rating.

Rating productivity may also involve interfacing with an internal or external calendar application to determine how much of an individual's or team's time was occupied by non-productive tasks, such as organizational meetings, or at least meetings not related to a current project. If the calendar indicates that some employees were able to produce as many accomplishments as others, but had to spend time on non-productive efforts (e.g., interviewing job applicants, meeting with a patent attorney), those employees may be awarded higher productivity ratings.

The other primary criterion, reputation, may be measured via explicit reputation points awarded by employees. For example, collaboration tool 138, profiles 132 or some other organizational tool may allow employees to award “karma points” or other tokens to other employees. Reasons for awarding a point may or may not be important or even recorded, and could therefore be professional and/or personal. In general, however, a given employee may be unlikely to wholly endorse another employee (i.e., the other employee, not just a particular skill of the other employee) if the given employee does not value that other employee.

In general, the data used to derive ratings for the primary criteria (and, possibly some secondary criteria), or metadata describing such data, may be stored within the organization (e.g., in an internal repository of system 130) and used when an internal recruiter or other organization official requests recommendations for a new project.

The official may simply use an interface exposed by system 130 to identify a set of skills needed for the project, or a set of skills that would likely be used by anyone selected for the project. The system then lists teams and/or individuals and their ratings with regard to the identified skills and/or other criteria (e.g., productivity, reputation, location). This set of results may, for example, be a list of existing teams that have ratings for the skills, may be a list of individuals with ratings for the skills, may be a list of suggested combinations of individuals to form new teams, or some combination of individuals, existing teams and new teams.

The official may be able to inquire into any team or individual, to identify the members of a team, for example, to see specific ratings for some or all skills and/or for other criteria, to determine how a team or individual received the assigned rating, etc. He or she may be able to sort the results differently, perhaps according to another criterion or some other factor (e.g., location, date of availability, team size).

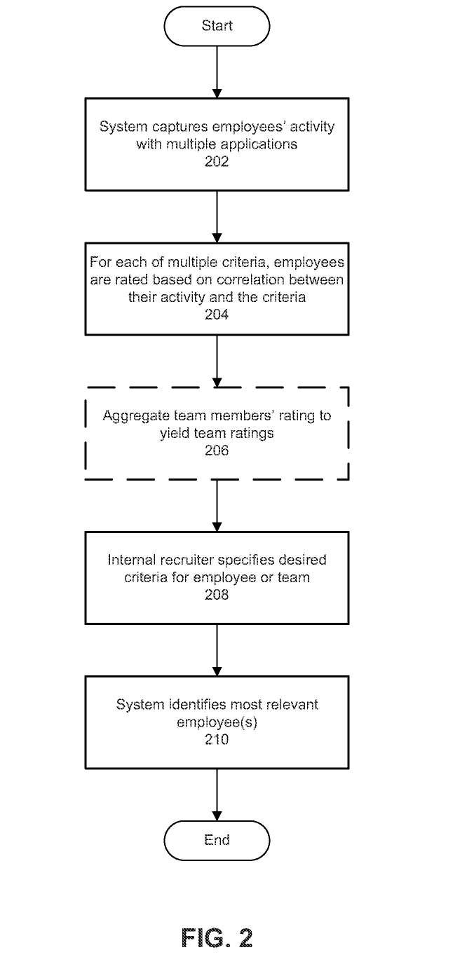

FIG. 2 is a flow chart demonstrating a method of recommending employees and/or teams of an organization for a project or role, according to some embodiments of the invention.

In operation 202, an organization's automated recommendation system continuously, regularly or periodically receives or harvests pertinent data from multiple applications and services operated by the organization and/or other parties. For example, and as described above, a centralized collaboration application within the organization may assemble myriad data regarding employees' projects, tasks, communications, interactions, etc.

The recommendation system may supplement this internally generated data with data extracted or received from external applications/services that further reflect employees' skills, experience, education, communications and/or other activities. For example, the system may access repositories depicted in FIG. 1, and/or others, and selectively extract information regarding particular criteria and employees. Thus, a code repository may be accessed to determine how many new source code files were stored by a software engineer, a document repository may be accessed to determine how many marketing presentations were created and stored by a marketing employee, a CRM database may be accessed to determine how many client communications were initiated by a sales associate and how well those communications were received by the clients, and so on.

Although data reflecting employees' activities may be retrieved from within and/or without the organization, in some embodiments the focus is upon internally generated information, regardless of whether it is stored internally or externally. Heretofore, organizations have not been able to assemble so many disparate sets and types of information for use in internal recruiting efforts.

Operation 202 may continue or be repeated through the illustrated method, to ensure the system considers fresh information as it becomes available, such as to update its ratings of individual employees and/or teams of employees.

In summary, the data captured or accessed in operation 202 (the system may avoid copying data, so as to conserve storage resources) may vary widely from one embodiment of the invention, or one implementation, to another. If an employee is to be proactively rated regarding many criteria, and not just a few specific criteria pertaining to one new team role, the amount of data the system will have to find, or will try to find, will increase commensurately.

With the gathered information, the system can correlate employees with different predetermined criteria, such as skills, reputation, productivity, experience, job/position titles they have held, job performance, products or projects they have worked on, communication skills, other employees with whom they have worked, availability (e.g., expected completion date of a current project), etc. Such correlation may entail rating how well an employee matches the specified criteria in an over-all sense. Individual values, scores or ratings may or may not be generated for each criterion, but at least one final rating or ranking will be generated for the employee for a given set of criteria.

Regarding the organization's collaboration tool, the system may automatically and selectively analyze specific types of data determined by the criteria for which the employee is being rated. For example, if the criteria include things like “communication” or “camaraderie” or “ability to work in a team”, then the employee's communications with other employees may be reviewed—possibly including electronic mail notes, instant messages, etc. If the criteria instead include things like “timeliness” or “productivity,” his communications may be bypassed in favor of notes or posts regarding completed tasks, a schedule according to which he was supposed to complete tasks (and information indicating whether or not he did) and/or other relevant data. With employees' skills generally being an important criterion, the system will capture explicitly identified skills (e.g., explicit skill endorsements from colleagues) and/or implicit skills (e.g., from presentations or papers generated by the employee).

In operation 204, for each of the predetermined criteria, and for multiple values of a given criterion where applicable, the system calculates a match or relevance between that criteria/value and each of multiple (or all) employees. A criterion such as skills, for example, could have myriad values—such as “enterprise systems,” “C++ programming,” “user interface design” and so on, and alphanumerical values, positive/negative values or other values may be assigned to an employee for each one to indicate how much of that experience she has.

For each of the predefined criteria, an employee's activity is analyzed to determine whether, or to what extent, the employee personifies or exhibits the criteria. For example, if a particular software engineer has worked on several projects dealing with mobile communication platforms, his activity as captured by the system will reflect that. Past job titles may include the word “mobile,” conversations with other employees may frequently mention specific mobile platforms (e.g., Windows CE, Android, iPhone), he may have generated presentations comparing different mobile technologies, etc. In this case, this employee will have a high relevance rating regarding skill in “mobile communication” platforms. A different employee who works in marketing and has primarily dealt with very different products would have a low relevance rating for subject matter expertise in mobile communication platforms.

As another example, many employees may engage in online conversations regarding “computer security,” but not all of them can be considered knowledgeable in that area. Investigation of other data, however, may increase particular employees' ratings for that topic. For example, if those online conversations frequently feature employees asking questions of a particular employee, this may indicate that the particular employee is more knowledgeable than others. If she has authored multiple presentations within and/or without the organization, which may be determined by examining the author field or originator of documents uploaded to a SlideShare or Dropbox repository, for example, her rating may further increase. If a performance appraisal specifies that she is a company expert in computer security, and/or her company profile reveals that multiple employees have endorsed her security skills, these facts may boost her to a top rating for that topic.

More explicitly, using a collaboration tool or other service, the system may receive direct endorsements of employees, for specific skills, for productivity, for communications and/or other criteria. In different implementations, an explicit rating may be delivered using an alphabetic or numeric scale, or may be simply indicate that, in the opinion of the employee performing the rating, the rated does or does not match the particular criterion.

In some embodiments of the invention, a rating for an employee regarding a given criterion begins at some median, average or other default value, and changes as data showing that the employee does (or does not) exhibit that criterion. Different criteria will be expressed differently and will therefore have different initial values.

For example, some criteria may be recorded as simply “yes” and “no,” such as criteria relating to whether an employee is willing to relocate, whether an employee has a four-year degree, whether she has earned the CISSP (Certified Information Systems Security Professional) qualification, etc. Other criteria may take alphabetical (e.g., A-F), numerical (e.g., 0-10) or alphanumerical ratings indicating the degree to which an employee matches them, such as “information security knowledge,” “enterprise systems,” “management of large client accounts,” “communication skills,” and so on. Yet other criteria take specific descriptive values, such as “Java skills,” “task accomplishment,” etc.

As the system obtains and analyzes an employee's activities within the organization's collaboration tool, and reviews any external profiles or repositories that may be relevant, the default value for a criterion will be adjusted accordingly. Therefore, criteria relating to specific skills or knowledge of a given employee may change to indicate that the system has (or has not) found evidence that the employee possesses those skills or that knowledge.

In optional operation 206, for existing teams within the organization, ratings of team members are aggregated to yield a rating for the entire team. For each criterion, the team members' ratings are separate aggregated but, in addition, an overall rating may be assigned to a team (and/or individual employees) based on a combination of the ratings for the separate criteria.

For the purpose of assembling this aggregate rating, criteria may be weighted. Illustratively, a set of primary criteria (e.g., skills, reputation, productivity) may be weighted more than secondary criteria. Further, multiple aggregate ratings may be generated using different weights for the separate criteria. For example, to provide flexibility to an internal recruiter (i.e., someone who fills roles and jobs from among the organization's employees) when seeking recommendations, the system may generate separate aggregate ratings in which each of multiple different criteria are weighted most heavily. This allows the recruiter to specify that, for example, productivity will be the most important factor for a new project (e.g., perhaps the project involves a great number of tasks), or that the existing team that is available the soonest is preferred, etc.

In operation 208, an official of the organization (e.g., an internal recruiter) feeds a set of criteria to the automated recommendation system, with corresponding values as necessary. In the illustrated embodiment of the invention, these criteria are a subset of the criteria for which the organization's employees were rated in operation 204. The submitted criteria may identify characteristics desired in an existing team or in employees to be assembled for a new team, in employees to be considered for a promotion or a new position within the organization, or for some other reason.

When a team is being assembled, one set of criteria may be identified for all team members, different criteria may be specified for different team members, or some common criteria may be expressed for all roles as well as specific criteria for individual roles. For example, for a new product team the organization may plan on assembling two software engineers, a designer and a product manager. For each role, different criteria may be specified.

Thus, preferred criteria for the software engineers may include experience with enterprise systems and knowledge of C++, Java and/or other programming languages. For the designer, a background with mobile platforms may be desired, and for the product manager, experience with enterprise systems may be desired.

In some embodiments of the invention, in which some criteria have ranges of values, the internal recruiter or other organization employee defining the role for which employees will be considered may specify a corresponding value or range of values that are acceptable. For example, a software engineer may need to have programming skills rated as at least 6 out of 10, the product manager should have at least 3 years of experience with enterprise systems, and so on.

In other embodiments of the invention, the official may simply identify a set of skills the team will need. The official may also specify that only existing teams of employees should be recommended, or only individual employees, or beneficial groupings of employees currently part of different teams, etc.

In operation 210, the system produces the results of matching the desired criteria identified in operation 208 and the employee relevance ratings calculated in operation 204. Depending on how the criteria identified in operation 208 were ranked or prioritized, different teams and employees may have higher or lower relevance ratings. Thus, if the software engineers' knowledge of the specified programming languages was specified as being of higher priority than experience with enterprise systems, one team of engineers may be more highly rated (and recommended) than another.

Similarly, identifying one position in a team as being the most (or least) important may also affect the employees' rankings. For example, if the product manager position is most important, relevance ratings of candidates for the other positions may be affected by whether they have or have not worked with the top-rated candidate(s) for the product manager position. In other words, for each employee suggested for the product manager position, a different set of employees may be suggested for other positions. Illustratively, this may occur based on who has worked well with each employee suggested for the product manager role. Those candidates for engineer and designer roles who worked with a particular product manager before, on successful projects, without any indication of conflict (or conversely, with explicit indications of a successful working relationship), may be ranked higher for their candidate roles.

Employee recommendations may be further affected by the composition of other teams or projects they were part of. For example, if a candidate is needed for a singular role in a team, such as one marketing person working with several engineers, marketing employees who have previous experience working with teams of engineers may be preferred to those who do not have such experience.

Dynamic criteria included in those specified in operation 208 may alter an employee's ranking based on facts not considered during operation 204. For example, if the team's work location is specified as being in Virginia, a team or employee located in California may be ranked lower than a team or employee whose attributes don't correlate as well with other criteria but who is located in Virginia. Again, the priority of the various criteria of operation 208 may affect the system's recommendations. Even if the team's work location is important, if the organization is willing to relocate a remote employee, the California candidate may retain a high ranking

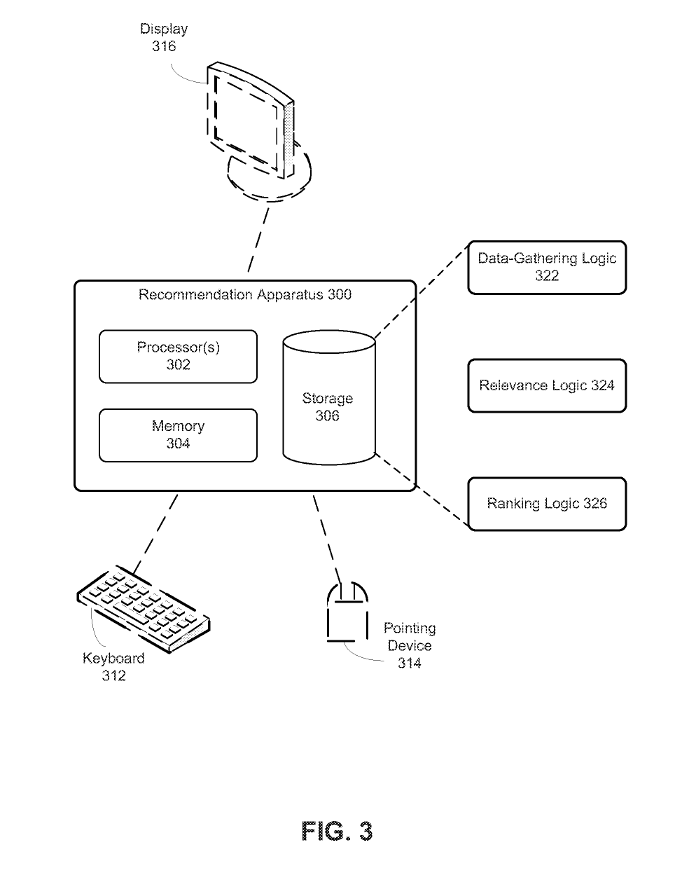

FIG. 3 is a block diagram of an apparatus for recommending an organization's employees for specified roles, according to some embodiments of the invention.

Apparatus 300 of FIG. 3 comprises one or more processor(s) 302, memory 304 and storage 306, which may comprise one or more optical and/or magnetic storage components. Apparatus 300 may be coupled (permanently or transiently) to keyboard 312, pointing device 314 and display 316.

Storage 306 of the recommendation apparatus stores logic that may be loaded into memory 304 for execution by processor(s) 302. Such logic includes data gathering logic 322, relevance logic 324 and ranking logic 326.

Data-gathering logic 322 comprises processor-executable instructions for receiving or retrieving data regarding activity of an organization's employees. The data may be produced or managed by multiple different applications and/or services operated by the organization to facilitate employees' work. The data-gathering logic may comprise APIs coupled to such applications and/or logic for connecting to a data repository of an application (e.g., an externally hosted application) and extracting relevant data.

Data gathered by data-gathering logic 322 may include data of any type, such as word processing documents, communications (e.g., electronic mail, instant messages), presentations, slide decks, performance appraisals and so on, and/or metadata regarding such documents. Illustratively, the metadata may allow the apparatus to retrieve the documents when needed instead of requiring the system to retain a large dataset.

When a new document or set of data is created in one of the applications/services linked to the recommendation apparatus, it may be posted to or by the apparatus (e.g., to a team or employee profile), and/or may be parsed, indexed, summarized or otherwise processed to extract intelligence for assisting the apparatus in calculating correlations between employees and specified criteria. For example, each new document may be analyzed as it is encountered by the recommendation apparatus, and used to update one or more associated employees' relevance ratings.

In some embodiments of the invention, data-gathering logic 322 includes or is part of a collaboration application, service or tool operated by the organization and described above.

Relevance logic 324 comprises processor-executable instructions for correlating employees with specified criteria, using data gathered by data gathering logic 322. Logic 324 may filter, process and analyze the data to determine if or how well it indicates that the criteria apply to an employee. This may require searching for key words, semantic analysis, pattern-matching and/or other processing.

The criteria may relate to professional knowledge or capabilities, work experience, professional qualifications or certifications, familiarization or expertise with different technologies, etc. In some embodiments of the invention, analysis of gathered data allows relevance logic 324 to compute, for each of multiple employees and/or existing team, a relevance rating between 0 and 1 for each criterion. A rating of 0 may indicate no correlation between the employee and the criterion, and a rating of 1 may indicate exceptional correlation. Other ratings may be applied in other implementations.

Ranking logic 326 comprises processor-executable instructions for ranking employees based on the relevance ratings produced by relevance logic 324 and/or other factors. In some embodiments of the invention, the relevance ratings for some criteria (e.g., criteria related to professional knowledge, experience and so on) may be regularly updated as new data are received or obtained. Other factors involved in an employee's ranking, however, may be specified when an organization's internal recruiter or manager uses recommendation apparatus 300 to obtain recommendations, or may be set at some other time and only updated when they change.

In particular, criteria that may or may not be correlated by relevance logic 324 may include things such as work location, expected date of availability for a new project, planned vacation dates, desire to relocate, ability to telecommute, and so on. While relevance ratings produced by logic 324 for primary criteria may significantly affect employees' ranking for recommendation for a team or position for which selected criteria have been identified, these “secondary” criteria or factors may also have an effect.

Thus, when recommendation apparatus 300 receives a set of criteria pertaining to creation of a new team or filling a position within the organization, ranking logic 326 may use relevance ratings from relevance logic 324 in its ranking of employees. Employees having little or no correlation to a criterion deemed “required” (e.g., employees having relevance ratings below a particular threshold for that criterion) may be completely omitted from the ranking. Depending on the prioritization of different criteria, ranking logic 326 will operate differently for different team/position recommendations, and rank the same collection of employees differently, even though their relevance ratings for individual criteria may not change between those recommendations.

Thus, when activated to recommend employees for a team or position within the organization, recommendation apparatus 300 accepts a list of criteria and outputs a list of employees, for each team role or position, in order of ranking and/or with explicit rankings Data supporting an employee's rating or ranking (or links to such data) may also be provided. The input criteria may be prioritized, may be formatted to identify “required” and/or “optional” criteria, to identify desired values for some criteria (e.g., current work location, date of availability), threshold relevance ratings and/or other factors.

In some embodiments of the invention, correlation between employees and attributes of a team role or position may be described as multi-dimensional data analysis. In these embodiments, each criterion of a role or position amounts to one dimension of the analysis. Each document or other set of data may be considered to be analyzed in the multiple dimensions to determine whether and how they affect an employee's relevance ratings for those dimensions.

The environment in which some embodiments of the invention are executed may incorporate a general-purpose computer or a special-purpose device such as a hand-held computer or communication device. Some details of such devices (e.g., processor, memory, data storage, display) may be omitted for the sake of clarity.

Data structures and code described in this detailed description are typically stored on a non-transitory computer-readable storage medium, which may be any device or medium that can store code and/or data for use by a computer system. Non-transitory computer-readable storage media includes, but is not limited to, volatile memory, non-volatile memory, magnetic and optical storage devices such as disk drives, magnetic tape, CDs (compact discs), DVDs (digital versatile discs or digital video discs), or other non-transitory computer-readable media now known or later developed.

The methods and processes described in the detailed description can be embodied as code and/or data, which can be stored in a non-transitory computer-readable storage medium as described above. When a processor or computer system reads and executes the code and/or data stored on the medium, the processor or computer system performs the methods and processes embodied as data structures and code and stored within the medium.

Furthermore, the methods and processes described below can be included in hardware modules. For example, the hardware modules may include, but are not limited to, application-specific integrated circuit (ASIC) chips, field-programmable gate arrays (FPGAs) and other programmable-logic devices now known or later developed. When the hardware modules are activated, the hardware modules perform the methods and processes included within the hardware modules.

The foregoing descriptions of embodiments of the invention have been presented for purposes of illustration and description only. They are not intended to be exhaustive or to limit the invention to the forms disclosed. Accordingly, many modifications and variations will be apparent to practitioners skilled in the art. The scope of the invention is defined by the appended claims, not the preceding disclosure.

1. A system for recommending only employees of an organization for a role within the organization having an associated set of criteria, the system comprising:
for each of one or more applications other than an application for recommending an employee for the role, a connection to an application-specific repository of data, wherein the application-specific data are generated from the employees' activity with the application and the applications include one or more of:
a human resources application;
a customer relationship management application; and
a social networking application;
a collaboration tool operated by the employees to collaborate on work projects internal to the organization, wherein collaboration data generated during the employees' collaboration is accessible only to employees of the organization;
a processor configured to:
for each of the employees, analyze the application-specific data and the collaboration data for correlation between the employee and the set of criteria, wherein the set of criteria comprises:
skills,
reputation, and
productivity of the employee demonstrated during the employee's employment with the organization, as embodied in the application-specific data and the collaboration data;
rate each employee's correlation with each criterion in the set of criteria based on the application-specific data and the collaboration data;
receive a subset of the set of criteria identifying desired attributes of a new role within the organization; and
recommend one or more of the employees for the new role, based on the ratings; and
a memory.

2. The system of claim 1, wherein the processor is further configured to:
update an employee's rating for one or more criteria in the set of criteria, in response to receipt of new application-specific data.

3. The system of claim 1, wherein all of the employees belong to a single organization that operates the one or more applications.

4. The system of claim 1, wherein each of the one or more applications includes a separate access control mechanism.

5. The system of claim 1, wherein:
the new role is a role internal to the organization; and
all of the employees are employees of the organization.

6. (canceled)

7. The system of claim 1, wherein:
the collaboration tool is configured to automatically populate employee profiles with their activity with the collaboration tool; and
the employee profiles are viewable within the organization by employees of the organization but are not viewable outside the organization.

8. The system of claim 7, wherein the processor is further configured to:
receive, from an employee, an endorsement of a second employee;
update a profile of the second employee to include the endorsement; and
update a rating of the second employee based on the endorsement.

9. (canceled)

10. The system of claim 1, wherein the subset of criteria is received from an internal recruiter within the organization.

11. A method of recommending only employees of an organization for a role defined by one or more criteria, the method comprising:
for each of one or more applications other than an application for recommending an employee for the role, accessing an application-specific repository of data, wherein the application-specific data are generated from the employees' activity with the application and the applications include one or more of:
a human resources application;
a customer relationship management application; and
a social networking application;
a collaboration tool operated by the employees to collaborate on work projects internal to the organization, wherein collaboration data generated during the employees' collaboration is accessible only to employees of the organization; and
operating one or more processors to:
for each of the employees, analyze the application-specific data and the collaboration data for correlation between the employee and the set of criteria, wherein the set of criteria comprises:
skills,
reputation, and
productivity of the employee demonstrated during the employee's employment with the organization, as embodied in the application-specific data and the collaboration data;
rate each employee's correlation with each criterion in the set of criteria based on the application-specific data and the collaboration data;
receive the one or more criteria identifying desired attributes of a new role within the organization; and
recommend one or more of the employees for the new role, based on the ratings.

12. The method of claim 11, further comprising operating the one or more processors to:
maintain a set of social employee profiles reflecting professional attributes of the employees, wherein the employee profiles are viewable by employees of the organization but are not viewable external to the organization.

13. The method of claim 12, further comprising operating the one or more processors to:
update a first employee's social employee profile in response to social input of one or more other employees; and
update a rating of the first employee regarding criteria related to the social input.

14. A non-transitory computer-readable medium storing instructions that, when executed by a processor, cause the processor to perform a method of recommending only employees of an organization for a role within the organization having an associated set of criteria, the method comprising:
for each of one or more applications other than an application for recommending an employee for the role, accessing an application-specific repository of data, wherein the application-specific data are generated from the employees' activity with the application and the application include one or more of:
a human resources application;
a customer relationship management application; and
a social networking application;
hosting a collaboration tool operated by the employees to collaborate on work projects internal to the organization, wherein collaboration data generated during the employees' collaboration is accessible only to employees of the organization;
for each of the employees, analyzing the application-specific data and the collaboration data for correlation between the employee and the set of criteria, wherein the set of criteria comprises:
skills,
reputation, and
productivity of the employee demonstrated during the employee's employment with the organization, as embodied in the application-specific data and the collaboration data;
rating each employee's correlation with each criterion in the set of criteria based on the application-specific data and the collaboration data;
receiving a subset of the set of criteria identifying desired attributes of a new role within the organization; and
recommending one or more of the employees for the new role, based on the ratings.

15. Apparatus for recommending only employees of an organization for a role defined by a set of criteria, the apparatus comprising:
connections to multiple data repositories storing application-specific data generated by multiple different applications operated by employees of the organization, wherein the applications include one or more of:
a human resources application;
a customer relationship management application; and
a social networking application;
a collaboration tool operated by the employees to collaborate on work projects internal to the organization, wherein collaboration data generated during the employees' collaboration is accessible only to employees of the organization;
one or more processors;
data-gathering logic executable by the one or more processors to receive data reflecting each employee's correlation with multiple specified criteria, wherein the data include the application-specific data and the collaboration data, and the criteria comprise:
skills,
reputation, and
productivity of the employee demonstrated during the employee's employment with the organization, as embodied in the application-specific data and the collaboration data;
relevance logic executable by the one or more processors to rate each employee's correlation to each specified criterion based on the application-specific data the application-specific data and the collaboration data; and
ranking logic executable by the one or more processors to recommend one or more of the employees for a role within the organization associated with a subset of the specified criteria.

16. The apparatus of claim 15,
wherein the collaboration tool records work activities of the employees that evidence one or more of the criteria.

17. The apparatus of claim 15, further comprising:
social logic executable by the one or more processors to:
maintain employee profiles viewable within the organization but not viewable external to the organization;
receive from one employee of the organization a professional endorsement of a second employee of the organization;
update an employee profile of the second employee; and
update a rating of the second employee to reflect greater correlation between the second employee and a criterion associated with the professional endorsement.

18. The apparatus of claim 15, wherein:
the multiple data repositories are external to the organization; and
the collaboration data are internal to the organization.

19. The system of claim 1, wherein:
the multiple application-specific repositories of data are external to the organization; and
the collaboration data are internal to the organization.
